(19) United States
(12) Patent Application Publication
(10) Pub. No.: US 2020/0225542 A1
(43) Pub. Date: Jul. 16, 2020

(54) MATERIALS AND METHODS OF MAKING PHOTO-ALIGNED VERTICAL ALIGNMENT LAYER FOR LIQUID CRYSTAL DEVICES

(71) Applicant: The Hong Kong University of Science and Technology, Hong Kong (CN)

(72) Inventors: Chenxiang ZHAO, Hong Kong (CN); Man Chun TSENG, Hong Kong (CN); Cuiling MENG, Huizhou City (CN); Shu Tuen TANG, Hong Kong (CN); Hoi Sing KWOK, Hong Kong (CN)

(21) Appl. No.: 16/831,374

(22) Filed: Mar. 26, 2020

Related U.S. Application Data
(62) Division of application No. 16/014,155, filed on Jun. 21, 2018.
(60) Provisional application No. 62/707,345, filed on Oct. 31, 2017.

(51) Int. Cl. G02F 1/1337; C09K 19/56; C09K 19/38; C09D 179/08; C09K 19/60

(52) U.S. Cl. CPC G02F 1/133723; G02F 1/133788; C09K 19/56; G02F 2001/133742; C09D 179/08; C09K 19/601; C09K 19/38

(57) ABSTRACT

Devices and methods relating to a vertical alignment layer with a preferred azimuthal angle for a liquid crystal device are provided. A method of preparation comprises preparing an alignment layer mixture of a polymeric vertical alignment material, an azo compound photo-aligned material, a reactive mesogen or liquid crystal monomer, a polyamic acid, a photo- or thermal-initiator, and an organic solvent, coating the alignment layer mixture onto a substrate, and irradiating the coated substrate with UV or blue light at an oblique angle.

### CROSS-REFERENCE TO RELATED APPLICATIONS

This application is a divisional of U.S. application Ser. No. 16/014,155, filed Jun. 21, 2018; which claims the benefit of U.S. provisional application Ser. No. 62/707,345, filed Oct. 31, 2017, which is hereby incorporated by reference in its entirety including any tables, figures, or drawings.

### FIELD OF INVENTION

Embodiments of the subject invention relate to an alignment technology for a vertically aligned nematic (VAN) liquid crystal display (LCD).

### BACKGROUND OF THE INVENTION

LCDs operate by manipulating the alignment configuration of liquid crystals inside of the LCD. The alignment configuration of the liquid crystals is the result of interactions between LC materials, an applied electric field, and an alignment layer. The quality of the alignment layer directly affects the performance of the LCD. Alignment layers for LCDs are conventionally prepared with a rubbed polyimide. LCDs generally use two types of alignment layers, vertical and planar. The vertical alignment layer provides a pretilt angle of approximately 90° and the planar alignment layer provides a small pretilt angle in a range of 0° to approximately 10°. A rubbing process can be used to achieve a preferred axis or azimuthal direction of the liquid crystal orientation near the alignment layer surface.

For a vertically aligned nematic (VAN) LCD, the liquid crystal molecules are aligned vertically to the alignment layer when there is no applied electric field. With crossed polarizers, a normally black VAN LCD can have a very high contrast ratio and a wide viewing angle. When an electric field is applied, the liquid crystal molecules tend to align perpendicularly to the electric field, in which case the liquid crystals have a negative dielectric anisotropy. Since the liquid crystal molecules are in a vertical position originally and there is no preferred azimuthal direction, the liquid crystals will tilt towards random azimuthal angles. In order to remove this kind of azimuthal angle degeneracy, the vertical alignment layer can be mechanically rubbed as is the case in a twisted nematic (TN) LCD.

Mechanical rubbing on an alignment layer can cause debris, electrostatic charges, non-uniform alignment, and mechanical damage. These conditions can lead to degradation of the LCD electro-optical properties or reduction of the production yield. These conditions may be even worse for a thin-film-transistor (TFT) LCD with a very high pixel density. Other disadvantages of mechanical rubbing may include difficulty with an increasing glass substrate size and creating multiple alignment domains within pixels.

For vertically aligned nematic LCD, a preferred azimuthal angle can be created by introducing protrusions inside a pixel. This approach is normally used in multi-domain VA-LCD (MVA) technology. A patterned electrode VA (PVA) LCD technology can be employed to use the fringe field to produce a preferred azimuthal angle. However one of the problems with the alignment control by either protrusions or a patterned electrode is the relatively slow switching response. This slow response is attributed to the non-uniformity of alignment control on the pixel surface area.

A photo-alignment method can produce a preferred azimuthal direction and is effective throughout the entire pixel area. Photo-alignment methods are non-contact alignment methods. A typical photo-alignment process comprises the following steps: (1) a photo-sensitive material is coated on the top of ITO glass, (2) the coated substrate is exposed to UV radiation, and (3) as a result of exposure to UV radiation a photo-aligned layer with a preferred alignment direction is formed. Most photo-alignment technologies can be divided into four categories: (1) cis-trans isomerization, (2) photo-degradation, (3) photo-crosslinking, and (4) photo-reorientation.

Examples of prior vertical alignment methods using photo-crosslinkable materials include the following:

An inclined homeotropic alignment was obtained by using slantwise non-polarized ultraviolet light (NP-UV) irradiation on a photo-crosslinkable methacrylate polymer. The polymer was dissolved in methylene chloride and spin-coated onto a quartz substrate resulting in a 100 nm thick film on the quartz substrate. The polymer was exposed to an NP-UV light at approximately 150 mW/cm² at 313 nm. The irradiation angle was in a range of 30° to 60°.

A photo-aligned vertical alignment cell was produced by using a photo-crosslinkable material, PMI5CA. The polymer was coated on an ITO coated glass substrate by spin-coating. The spin-coating resulted in a film with a uniform thickness of approximately 50 nm. Linear polarized UV (LP-UV) light at a wavelength of 285 nm was projected on the substrate at an oblique angle of 60°. During the oblique polarized light exposure, the cinnamate groups in the polymer were crosslinked through photo-dimerization.

Commercial photo-aligned vertical alignment material from Rolic® Technologies Ltd. is produced by photo-crosslinking cinnamate groups through oblique LP-UV irradiation.

Examples of prior methods to produce polyimide alignment materials include the following:

An inclined homeotropic alignment was produced by irradiation of NP-UV light on a polyimide film that originally exhibited homeotropic alignment. NP-UV light was irradiated from an oblique direction of 45°. This method involved an asymmetric destruction of the alignment effect of the alkyl chain. When the irradiation time was too short, the alignment was homeotropic (vertical), and when the irradiation time was too long, the alignment was homogeneous (planar) and the direction was random. This process used a photo-degradation method and had a limited process window.

A UV light stable polyimide (PI) material JALS 2021-R2 was mixed with a water soluble sulfonic azo dye (SD1) and then irradiated by obliquely incident non-polarized UV light. As a result, a VAN cell with perfect electro-optical performance was obtained. It is believed that the VAN cell alignment mechanism was mostly due to the average alignment effect of the PI/SD1 mixture, rather than the photo-degradation of the PI material.

### BRIEF SUMMARY OF THE INVENTION

The photo-aligned VA technology of the subject invention is neither a photo-crosslinking method nor a photo-degradation method. In an embodiment, first, the azo-dye alignment material is stabilized by the addition of a reactive mesogen or a liquid crystal polymer. The azo-dye alignment material can comprise azo-dye materials such as SD1 or a brilliant yellow dye. Second, an additional viscosity modifier is included to facilitate the offset printing of the alignment layer. Third, UV irradiation is replaced by blue LED light irradiation. This results in a stable, low cost material, produced by a process that is suitable for mass factory production.

Embodiments of the subject invention provide an alignment layer mixture comprising a polyimide type vertical alignment material, a homogeneous alignment capable azo dye, a reactive mesogen or a liquid crystal monomer, a viscosity modifier such as polyamic acid (PAA) or polyvinylpyrolidone (PVP), and a solvent. The solvent can be N-methyl-2-pyrrolidone (NMP) or another suitable organic solvent.

Embodiments of the subject invention provide a method of preparing an alignment layer comprising coating a photo-aligned VA solution onto a conductive and transparent substrate, removing excess solvent through a soft baking process, exposing the coated substrate to light in order to produce a preferred azimuthal direction, and hard baking the coated substrate to stabilize the alignment angle and direction.

### BRIEF DESCRIPTION OF THE DRAWINGS

FIG. 1 is a diagram of the basic structure of a liquid crystal device.

FIG. 2 is a diagram illustrating the definition of an azimuthal angle and a polar angle of a surface liquid crystal.

FIG. 3A is a diagram of liquid crystals in a homogeneous (planar) alignment. FIG. 3B is a diagram of liquid crystals in a homeotropic (vertical) alignment.

FIG. 4A is a diagram of a VAN cell in a voltage-off state. FIG. 4B is a diagram of a VAN cell in a voltage-on state.

FIG. 5A is a diagram of oblique light irradiation striking an alignment layer from a tilted light source. FIG. 5B is a diagram of oblique light irradiation striking an alignment layer on a tilted platform.

FIG. 6 is a diagram illustrating the molecular structure of the sulfonic azo-dye, SD 1.

FIG. 7 is a plot of the normalized absorbance of the SD1 material versus wavelength.

FIG. 8 is a plot of a transmittance voltage curve of a VAN LCD.

### DETAILED DISCLOSURE OF THE INVENTION

The following disclosure and exemplary embodiments are presented to enable one of ordinary skill in the art to make and use a photo-alignment layer according to the subject invention. Various modifications to the embodiments will be readily apparent to those skilled in the art and the generic principles herein may be applied to other embodiments. Thus, the devices and methods related to the photo-alignment layer are not intended to be limited to the embodiments shown, but are to be accorded the widest scope consistent with the principles and features described herein.

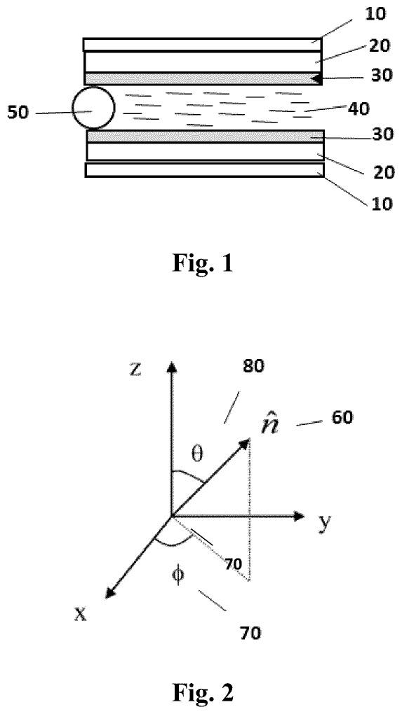

FIG. 1 shows a typical LC device constructed between two conductive glass substrates 20 that are each coated with a respective alignment layer 30 on one surface and each connected to a respective polarizer 10 on the opposite surface. Spacers 50 in between the two substrates 20 define the cell gap of the LC cell. Liquid crystals 40 are filled in between the two substrates 20. A function of the alignment layers 30 is to give the liquid crystal molecules 40 that are close to the alignment layers 30 a surface alignment direction, both azimuthal and polar.

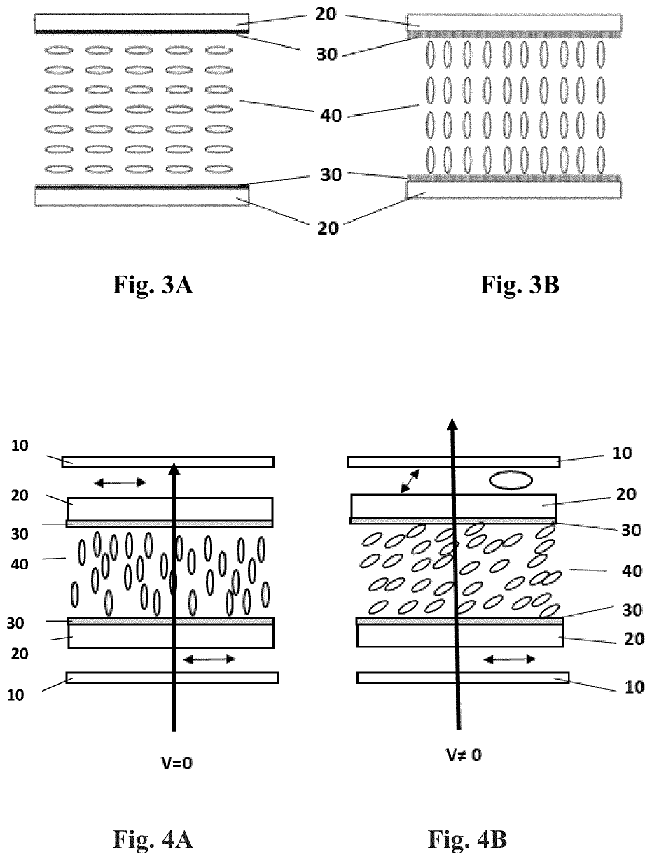

FIG. 2 illustrates an azimuthal angle 70 and a polar angle 80 of a surface liquid crystal. The x-y plane being the alignment layer surface, \hat{n} being the LC director, ϕ being the azimuthal angle 70, and θ being the polar angle 80. As seen in FIG. 3A, the homogeneous (planar) aligned LC cell has polar angle of 90°. As seen in FIG. 3B, the homeotropic (vertical) aligned LC cell has polar angle of 0°.

FIGS. 4A and 4B illustrate a typical VAN LCD operation. As seen in FIG. 4A, the LC molecules 40 are vertically aligned when there is no applied voltage. The crossed polarizer 10 blocks the light attempting to pass through the polarizer 10 resulting in a dark voltage-off state. As seen in FIG. 4B when a voltage is applied to the LC device, the LC molecules 40 tilt away from the normal direction of the substrate and light can pass through the polarizer 10 resulting in an illuminated voltage-on state.

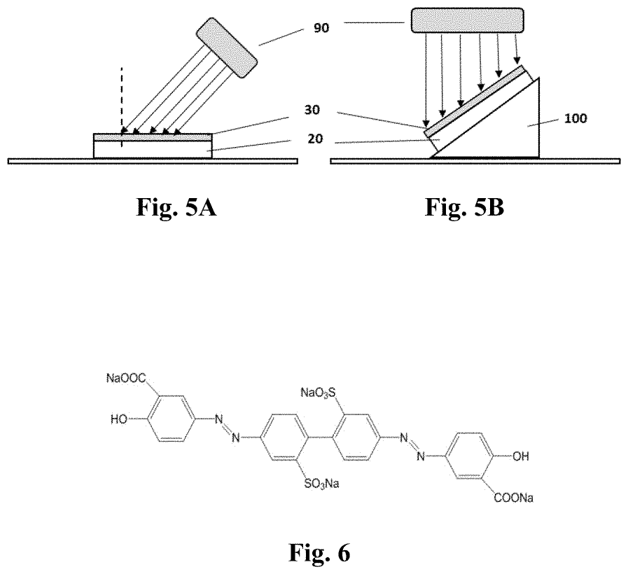

A small but non-zero polar angle in a preferred azimuthal direction can remove the azimuthal angle degeneracy in the voltage-on state. This small polar angle is created by oblique light irradiation on the substrate, as seen in FIGS. 5A and 5B. This can be done either by tilting the light source 90, as seen in FIG. 5A to irradiate an alignment layer 30 on a substrate 20 or tilting the alignment layer 30 on the substrate 20 with a platform 100, as seen in FIG. 5B.

The VA alignment material described herein can be made from vertical alignment polyimide (PI) material (e.g., SE-4811 from Nissan Chemicals or PIA-8520 from Chisso Corporation). These VA polyimide materials each provide a stable vertical alignment to the liquid crystals. Sulfonic azo dye, SD1, can be added to the PI material and irradiated with oblique light resulting in a non-zero polar angle and a preferred azimuthal direction. It should be appreciated by one of ordinary skill in the art that the sulfonic azo dye can be replaced by an azo compound or azo dye. An azo compound is a compound with the functional group R—N═N—R′, where R and R′ are an aryl or alkyl group. Azo dyes are compounds bearing the functional group R—N═N—R′, where R and R′ are an aryl group.

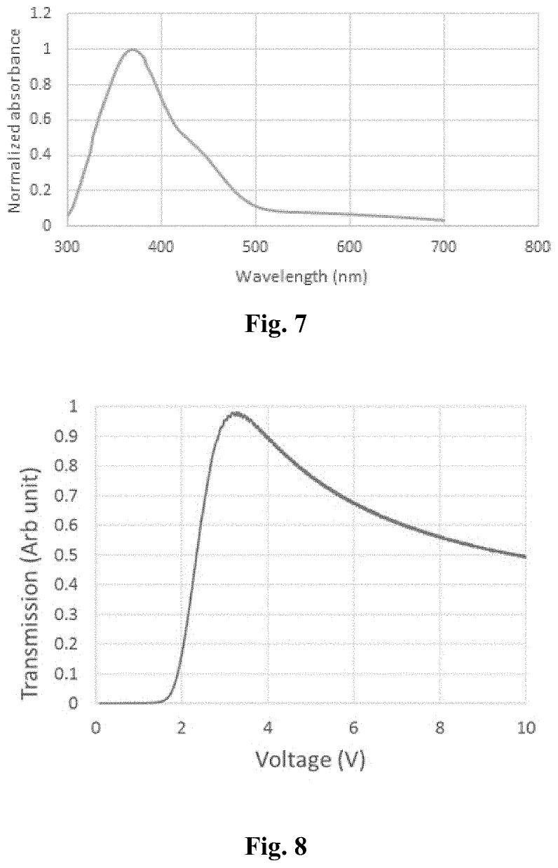

FIG. 6 shows the SD1 molecular structure. The light irradiation angle is typically 45° and instead of ultra-violet light, blue light can work well for the SD1 material. This can be demonstrated by examining the absorption curve of SD1, as seen in FIG. 7. FIG. 7 shows that the peak in absorption corresponds with a wavelength close to 365 nm and that there is significant absorption in the blue region of the color spectrum. Blue LED irradiation is comparatively safe and cost effective. Furthermore, during production, the coated substrates can be put on a conveyer belt and oblique light can be transmitted onto the continuously moving substrates.

Azo-dye orientation is rewritable by an incident linear polarized light and the following method can be used to stabilize the azo-dye orientation.

An alignment layer mixture can have a composition of ingredients in the following ranges: 0.05%-5.0% vertical alignment polyimide, 0.05%-5.0% azo compound or azo dye, 0.05%-5.0% monomer or polymer, 0.05%-5.0% viscosity modifier, and 0.01%-2.0% thermal initiator. In a preferred embodiment an alignment layer mixture has the following composition: 1.5% PI, 2% SD1, 2.5% RM257, 1.5% polyamic acid, and a small amount of thermal initiator. This alignment layer mixture has a solid content of around 7% and a viscosity of approximately 20 cP. A 5 μm cell gap VAN LCD was made and its transmittance versus applied voltage curve is shown in FIG. 8. In other embodiments, the viscosity modifier can comprise poly(pyromellitic dianhydride-co-4,4′-oxydianiline), an amide, an imide, a polyamide, a polyamine, or polyvinylpyrrolidone (PVP).

A method of making the photo-aligned VA alignment layer comprises the steps of: (1) preparing the alignment layer mixture, (2) coating the alignment layer mixture on a substrate, (3) soft baking the coated substrate at a temperature of approximately 100° C. for 10 minutes, (4) irradiating the coated substrate by UV/blue light obliquely (for example, at a 45° angle), and (5) hard baking the coated substrate at a temperature of approximately 200° C. for 1.5 to 2 hours.

A polymer can be coated onto a substrate via spin-coating, flexo-printing, ink-jet printing, bar-coating, knife coating, spray coating, screen printing, or other appropriate coating method. The substrate can comprise indium tin oxide (ITO) coated glass, ITO coated polyethylene terephthalate (PET) film, poly(3,4-ethylenedioxythiophene) polystyrene sulfonate (PEDOT:PSS), polyethylene Napthalate (PEN), polycarbonate (PC), cyclic-olefin-copolymer (COC), or other kind of transparent conductive film on other hard or flexible substrate. The organic solvent can comprise N-methyl-2-pyrrolidone (NMP), dimethyl-formamide (DMF), butyl-cellosolve (BC), gamma butyrolactone (GBL), or a mixture of one or more of the above described solvents. The oblique angle for light illumination can be in a range of 10° to 80° from the normal direction to the plane of the substrate. In certain embodiments, the light radiation can be transmitted at a single wavelength or at multiple wavelengths, wherein at least one wavelength is in a range of 300 nm to 470 nm. The light can be transmitted in a monotone color or multiple colors. The light source comprises a mercury lamp, a light emitted diode (LED), or a laser diode. In one embodiment, a plurality of light sources can be respectively configured to each transmit light at a respective angle different than an angle of a surface normal to a plane of the substrate. In certain embodiments, the light source can be configured to be linearly polarized.

The invention as presented herein and the specific aspects or embodiments illustrated or material used in examples are meant not to be limiting, but may include variations, modifications or adaptations pertaining to the principle of current invention. As noted all drawings presented are for illustration only, they are not drawn to scale nor are exact replicate of real devices.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

What is claimed is:

1. A method of preparing an alignment layer for a vertically aligned liquid crystal device, comprising:
preparing an alignment layer mixture comprising a polymeric vertical alignment material, an azo compound photo-aligned material, a monomer or a polymer, a photo- or thermal-initiator, and an organic solvent;
coating the alignment layer mixture onto a substrate; and
irradiating the coated substrate with UV or blue light at an oblique angle.

2. The method of claim 1, wherein the substrate comprises indium tin oxide (ITO) coated glass, ITO coated polyethylene terephthalate (PET), poly(3,4-ethylenedioxythiophene) polystyrene sulfonate (PEDOT:PSS), polyethylene Napthalate (PEN), polycarbonate (PC), or cyclic-olefin-copolymer (COC).

3. The method of claim 1, wherein the coating method comprises spin-coating, flexo-printing, ink-jet printing, bar-coating, knife coating, spray coating, or screen printing.

4. The method of claim 1, wherein the oblique angle is in a range of 10° to 80° from a surface normal to a plane of the substrate.

5. The method of claim 1, wherein at least one wavelength of the UV or blue light is in a range of 300 nm to 470 nm.

6. The method of claim 5, further comprising soft baking the coated substrate prior to irradiation.

7. The method of claim 6, wherein a temperature for soft baking is in a range of 80° C. to 120° C. for a time period in a range of 1 to 20 minutes.

8. The method of claim 1, further comprising hard baking the coated substrate after UV or blue light irradiation.

9. The method of claim 8, wherein a temperature for hard baking temperature is in a range of 160° C. to 220° C. for a time period in a range of 20 minutes to 2 hours.

10. The method of claim 1, wherein a light source for irradiation comprises a mercury lamp, a light emitted diode (LED), or a laser diode.

11. The method of claim 10, wherein the light source is linearly polarized.

12. The method of claim 1, wherein a light source for irradiation is configured to transmit light at an angle different than an angle of a surface normal to a plane of the substrate.

13. The method of claim 1, wherein a plurality of light sources for irradiation are respectively configured to each transmit light at a respective angle different than an angle of a surface normal to a plane of the substrate.

14. The method of claim 1, wherein preparing the alignment layer mixture further comprises including a viscosity modifier.
